(19) United States
(12) Patent Application Publication
(10) Pub. No.: US 2017/0177788 A1
(43) Pub. Date: Jun. 22, 2017

(54) Detection of High Variability Regions Between Protein Sequence Sets Representing a Binary Phenotype

(71) Applicant: ARIZONA BOARD OF REGENTS ON BEHALF OF ARIZONA STATE UNIVERSITY, Scottsdale, AZ (US)

(72) Inventors: Karen Anderson, Scottsdale, AZ (US); Immanuel Purushothaman, Tempe, AZ (US)

(73) Assignee: Arizona Board of Regents on behalf of Arizona Stat e University, Scottsdale, AZ (US)

(21) Appl. No.: 15/128,405

(22) PCT Filed: Mar. 18, 2015
(86) PCT No.: PCT/US15/21262

§ 371 Date: Sep. 22, 2016

Related U.S. Application Data
(60) Provisional application No. 61/970,287, filed on Mar. 25, 2014.

(51) Int. Cl. G06F 19/22; G06F 17/30; G06F 19/28

(52) U.S. Cl. CPC G06F 19/22; G06F 19/28; G06F 17/30477; G06F 17/30598

(57) ABSTRACT

A computer-based bioinformatics method for identifying protein sequence differences between sets of sequences grouped into different phenotype data sets that involves querying a database to identify common sequence motifs within a first phenotype data set and another phenotype data set of protein sequences, computing a pairwise correlation among motifs for each data set, and computing the variation between the data sets to identify one or more motifs that are conserved in a given data set and thus correlate with that data set's phenotype.

### CROSS-REFERENCE TO RELATED APPLICATIONS

This application claims priority to U.S. Provisional Patent Application No. 61/970,287 filed on Mar. 25, 2014.

### TECHNICAL FIELD

This invention relates in general to methods and materials for computationally identifying regions of higher variability between two protein sequences sets representing a binary phenotype, such as high risk and low risk human papillomavirus motifs from early gene proteins.

### BACKGROUND

One ongoing quest in the field of bioinformatics is the development of frameworks to be utilized for detection of sequence sites with high variability between two data sets of similar protein sequences but with different phenotypes.

For example, Human papillomaviruses (HPVs), with over 100 genotypes, are a very complex group of human pathogenic viruses and yet have relatively similar protein sequences. Oncogenic types of HPV may induce malignant transformation in the presence of cofactors. Indeed, over 99% of all cervical cancers and a majority of genital cancers are the result of oncogenic HPV types. Such HPV types have been increasingly linked to other epithelial cancers involving the skin, larynx and oesophagus.

Research investigating HPV oncogenesis is complex due to the inability to efficiently produce mature HPV virions in animal models. Thus, there has been ongoing limitations to fully elucidating oncogenic potential in HPV-infected cells. More generally, the ability to distinguish different phenotypes for similar protein sequences would be very useful.

### SUMMARY

This disclosure relates to novel methods for identifying sequence differences in a binary phenotype data set. For example, the methods can be applied to detection of potential therapeutic targets in high-risk HPVs by examining conserved regions within protein sequences of HPV early genes and searching for their presence in known low risk types.

Thus, in one embodiment, a computer-implemented bioinformatics method identifies protein sequence differences between sets of sequences grouped into different phenotype data sets. The method is carried out by querying a database to identify common sequence motifs within a first phenotype data set and another phenotype data set of protein sequences, computing a pairwise correlation among motifs for each data set, and computing the variation between the data sets to identify one or more motifs that are conserved in a given data set and thus correlate with that data set's phenotype.

Unless otherwise defined, all technical and scientific terms used herein have the same meaning as commonly understood by one of ordinary skill in the art to which this disclosure belongs. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the invention will be apparent from the following detailed description and figures, and from the claims.

### DESCRIPTION OF DRAWINGS

FIG. 1. Strategy for the Identification of Motifs Associated with High Risk HPV. High risk motifs were identified using MEME on the training set of 13 High Risk RefSeqs. These motifs were then applied to set of 12 Low Risk RefSeqs using MAST and the resulting frequency of each motif in the two sets was determined. In addition, MAST and BLAST were utilized to search these motifs in virus sequences in the NCBI protein database, Human ORFs, and HPV types outside the two designated risk categories.

FIG. 2. Map of HPV Proteins. The location of each of the significant locations are highlighted within each of their respective genes. In addition, known conserved motifs within these HPV early genes that were detected in this analysis but not filtered as significant to oncogenecity were also mapped. This includes the zinc binding sites of E6 and E7, pRB binding site of E7, and Di-Leucine motifs in the first domain of E5.

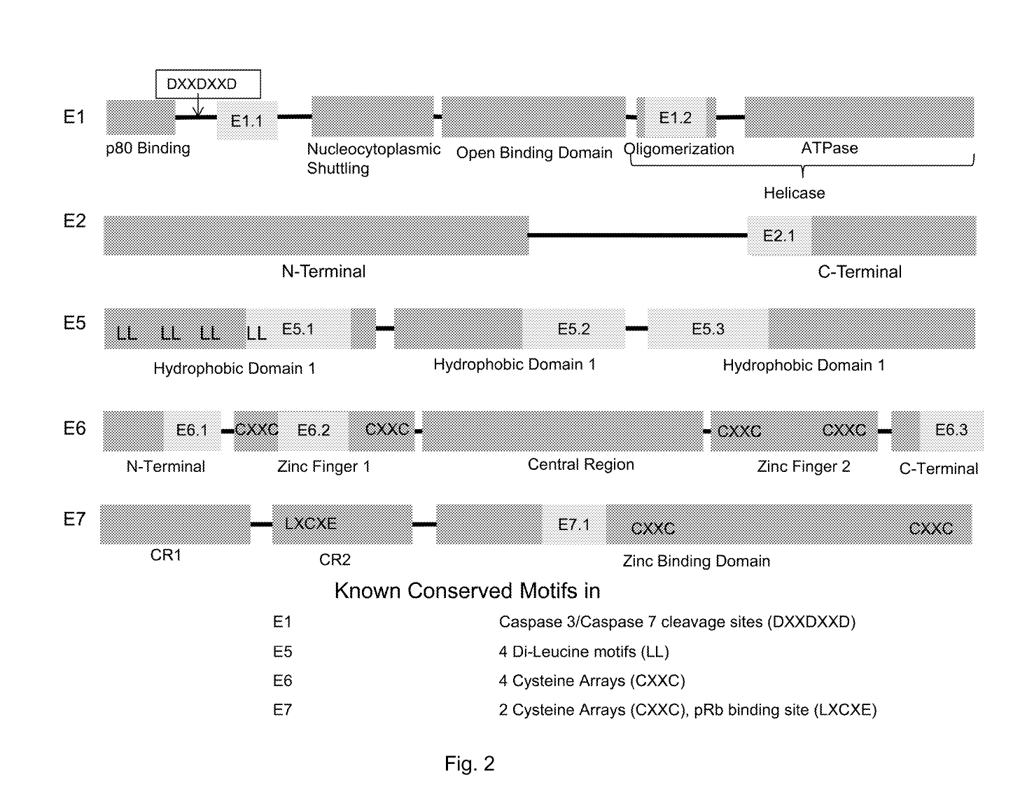

FIG. 3 shows in tabular format Statistically Significant Motifs, their Frequency in Each Data Set, and location in Gene and Putative Function. Performing a Chi-Square Test with Yate's Correction yielded 10 statistically significant motifs from the 112 determined by MEME. These motifs were then queried separately in a dataset of other HPV isolates of unclassified risk, whose frequencies are also displayed in the table. The amino acid range of each motif in HPV16 is also denoted, with the relative putative function, in the last two columns.

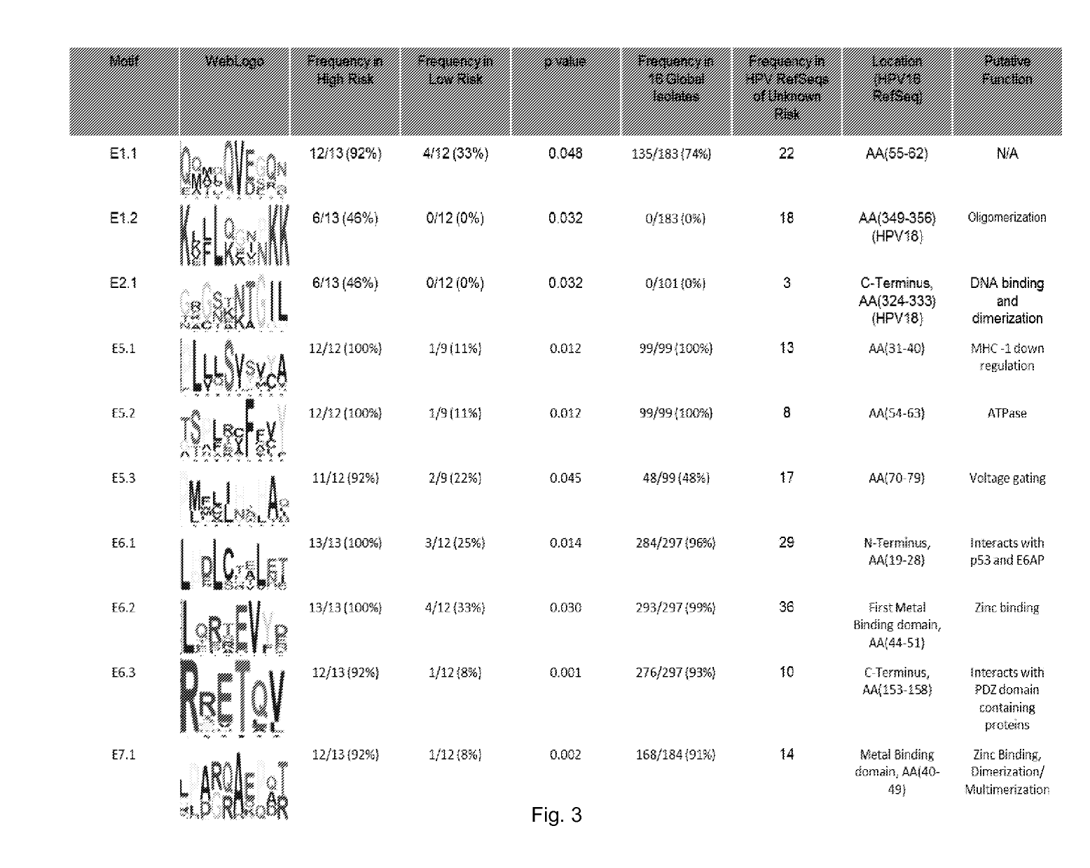

### DETAILED DESCRIPTION

The computational methods utilized in this study allow for detection of sequence sites with high variability between two data sets of similar protein sequences but with different phenotypes. In one embodiment, these methods are applied to the study of HPVs.

Previously studied sequence comparison techniques examined the phylogeny of sequences within a set, but are limited in revealing variation between sequences or data sets. For instance, in the context of HPVs, previous comparative genomics studies would either focus on one or two genes (primarily the known oncogenes E6 & E7) or investigate a few HPV types at a time, commonly HPV16, HPV18 and HPV45.

The bioinformatics methodology utilized herein provides a systematic, comprehensive and unsupervised approach for determining regions in the HPV proteome that contribute toward carcinogenesis. Statistically significant motifs indicate variation between HR (high risk) and LR (low risk) types in their respective regions of the proteome. These areas can then be viewed as sites that potentially contribute toward oncogenesis, and can be evaluated in light of putative function of protein regions. This approach also can be generalized for identifying variation between two different data sets.

The utilization of the methods herein has the potential to be used as a discovery tool for therapeutic targets for HPV. This serves as a precursor step to designing drugs to target significant regions to prevent malignant conversion. Moreover, these processes are a comprehensive and unbiased analysis that are translatable beyond HPV to investigate other viruses or different classes of proteins.

Embodiments will be further described in the following examples, which do not limit the scope of the invention described in the claims.

### EXAMPLES

In one embodiment of the methods, computational sequence analysis tools such as MEME and MAST (meme.sdsc.edu/meme/intro.html), as well as a statistical analysis, were utilized to determine the sequence motifs significant to oncogenicity for HPVs. MEME identifies short sequence features, motifs, that are conserved in a dataset of similar nucleotide or protein sequences. MAST is an alignment search tool using the outputs of MEME to search those motifs in a user-defined database or a public knowledge source. Along with these techniques, a Chi-Square test using Yate's Correction for continuity was utilized to find significant motifs present in both data sets.

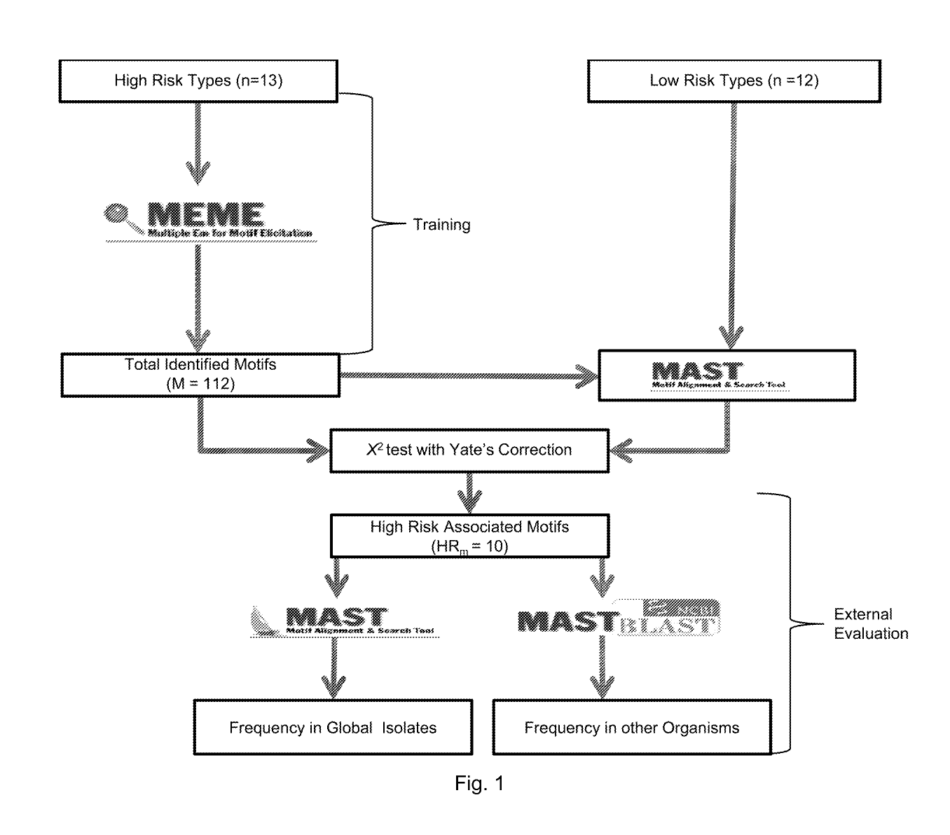

Turning to FIG. 1, the HPV protein reference sequences for thirteen high risk and twelve low risk types for genes E1, E2, E4, E5, E6, E7, L1 and L2 were retrieved from the NCBI RefSeq database (www.ncbi.nlm.nih.gov/RefSeq/). The high risk data set contained types HPV16, 18, 31, 33, 35, 39, 45, 51, 52, 56, 58, 59, and 68 while the low risk group were types HPV6, 11, 40, 42, 43, 44, 53, 54, 61, 72, 73 and 81. The HPV51RefSeq was devoid of gene annotation, and the reference sequence for HPV35 had an erroneous protein output for E2. These two RefSeqs were replaced with the whole genome entries P26554and P27220 from UniProtKB/Swiss-Prot.

In addition, due to limited annotation of the E4 and E5 genes in most of the RefSeq entries, their respective protein sequences were retrieved from the NIAID HPV database PaVe (pave.niaid.nih.gov), since it contained revised and re-annotated submissions of selected reference sequences. As a result, only 12 of the 13 high risk types and 9 of 12 low risk types had a designated E5 gene in PaVe.

To identify common sequence motifs within the HR HPV proteomes, the MEME (Multiple Em for Motif Elicitation) Suite (meme.sdsc.edu/meme/cgi-bin/meme.cgi) was employed. For each gene, the thirteen HR HPV types were evaluated using MEME, specifying a minimum motif width of six amino acids and a maximum of ten. Repetitions of motifs were enabled and the maximum number of motifs was adjusted based on the size of the gene. This ensured that no two elicited motifs possessed pairwise correlations beyond 0.60. This correlation was computed via MAST (Motif Alignment Search Tool) results generated from the MEME results. To determine the frequency of these motifs in LR HPV types, a separate MAST search was conducted on the twelve LR HPV types using the motifs identified in the HR HPV types. The frequency of motifs in each viral proteome were determined.

To quantify the variation between the two sets (HR HPV and LR HPV), the frequency of occurrence of individual high risk motifs in the twelve LR HPV types was evaluated. It assumed here that a motif that is preferentially conserved in HR HPV sequences, compared to LR HPV sequences, would have oncogenic potential. First, the presence of a motif in each type was identified, without regard for repeated occurrence. The number of HPV types possessing at least one occurrence for each motif was summed To select specific HR HPV motifs, a Chi Square test with Yate's correction for continuity was conducted for the frequency of each motif between the two data sets. This conservative correction was employed in order to avert overestimation of statistical significance.

The test for significance was established under the null hypothesis such that the frequency of a given motif in the high risk data set is the same as in the low risk data set. The hypothesis is thus negated (H1) if the frequency of a given motif in the high risk data set exceeds that of the low risk data set. Using one degree of freedom (for a binary data set), the p-values (=0.05) for each motif were computed and then used to rank the motifs.

The method illustrated above serves as a methodology for computationally identifying regions of higher variability between two protein sequences sets representing a binary phenotype, although evaluations of additional sets in excess of two is possible. This was specifically applied to determining sequence factors in high risk HPV that may be responsible for oncogenesis. These sites could potentially be targets for therapeutics to prevent malingancy as a result of high risk HPV infection. This process can be extrapolated to evaluate phenotypic differences within viruses, as well as investigating specific properties of similar proteins.

In the examples above, a non-transitory computer-readable storage medium containing a computer program for specifying the recited functionality may be used.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A computer-implemented bioinformatics method for identifying protein sequence differences between sets of sequences grouped into different phenotype data sets; comprising:
querying a database to identify common sequence motifs within a first phenotype data set and another phenotype data set of protein sequences;
computing a pairwise correlation among motifs for each data set; and
computing the variation between said data sets to identify one or more motifs that are conserved in a given data set and thus correlate with that data set's phenotype.

2. The method of claim 1, wherein said database comprises the Multiple Em for Motif Elicitation Suite.

3. The method of claim 1, wherein a minimum motif width of six amino acids and a maximum of ten amino acids are specified.

4. The method of claim 1, wherein said pairwise correlation is computed via the Motif Alignment Search Tool.

5. The method of claim 1, wherein the variation of frequency of each motif between the two data sets is computed via a Chi Square test with Yate's correction for continuity.

6. The method of claim 1, wherein oncogenicity is one of said phenotype data sets.

7. A computer-implemented bioinformatics method for identifying protein sequence differences between sets of Human papillomavirus sequences grouped into different phenotype data sets; comprising:
querying a database to identify common sequence motifs within a first phenotype data set and another phenotype data set of protein sequences;
computing a pairwise correlation among motifs for each data set; and
computing the variation between said data sets to identify one or more motifs that are conserved in a given data set and thus correlate with that data set's phenotype.
